(19) United States
(12) Patent Application Publication
(10) Pub. No.: US 2026/0016324 A1
(43) Pub. Date: Jan. 15, 2026

(54) CALIBRATION MODULE AND MEASUREMENT SYSTEM

(71) Applicant: HORIBA Advanced Techno, Co., Ltd., Kyoto-shi (JP)

(72) Inventors: Keisuke SASAI, Kyoto-shi (JP); Wataru KINOSHITA, Kyoto-shi (JP)

(21) Appl. No.: 19/261,630

(22) Filed: Jul. 7, 2025

(30) Foreign Application Priority Data
Jul. 9, 2024 (JP) 2024-110272

(51) Int. Cl. G01D 18/00

(52) U.S. Cl. CPC G01D 18/00

(57) ABSTRACT

A calibration module including a tank to hold a liquid, an inlet path connected to an inlet port of a sensor unit including a sensor to introduce the liquid supplied from the tank into the sensor unit, and an outlet path connected to an outlet port of the sensor unit to discharge the liquid from the interior of the sensor, in which the inlet path introduces the liquid into the sensor unit by the hydraulic head between the tank and the inlet port.

### CROSS-REFERENCE TO RELATED APPLICATION

The present application claims priority from Japanese Patent Application No. 2024-110272 filed Jul. 9, 2024, which is incorporated herein by reference in its entirety.

### BACKGROUND OF THE INVENTION

### Technical Field

The present invention relates to a calibration module and a measurement system.

### Description of the Related Art

In a measurement system in which a liquid is circulated through a flow path, and a sensor is used to detect a characteristic of the liquid flowing through the flow path, the flow rate of the liquid flowing through the flow path is controlled with an electric pump or valve or the like to stably circulate the liquid through the flow path.

### PRIOR ART DOCUMENT

### Patent Document

JP H4-89566 A

### SUMMARY OF THE INVENTION

Such a conventional measurement system requires a power source not only at the time of measurement but also at the time of calibrating a sensor, and has a problem that in a place where a power source cannot be secured or the like, measurement and calibration cannot be performed.

The present invention has been made in view of the above-described problem. It is a main object thereof to provide a calibration module of a very simple configuration that does not require a power source.

Specifically, a calibration module according to the present invention includes:
a tank to hold a liquid;
an inlet path connected to an inlet port of a sensor unit including a sensor to introduce the liquid supplied from the tank into the sensor unit; and
an outlet path connected to an outlet port of the sensor unit to discharge the liquid from the interior of the sensor,
in which the inlet path introduces the liquid into the sensor unit by the hydraulic head between the tank and the inlet port. The hydraulic head is energy generated between two liquid levels of different heights.

According to the calibration module configured like this, the sensor can be calibrated with a very simple configuration that does not require a flow rate control mechanism driven using electric power such as an electric pump or an electric valve.

It is preferable that an atmospheric opening provided on the outlet path is further included, and the atmospheric opening is provided at a higher position than the inlet port because the liquid introduced into the sensor unit can be discharged from the inlet port by the hydraulic head.

As a specific aspect of the present invention, a supply path to supply the liquid from the tank to the inlet path may be further included,
in which the liquid is supplied to the sensor unit when the supply path is connected to the inlet path.

It is preferable that a discharge path that is connected to the inlet path to discharge the liquid discharged from the sensor unit to the outside is further included, and
the liquid remaining in the supply path can be discharged when the connection destination of the supply path connected to the inlet path is switched to the discharge path and the end of the inlet path on the tank side is sealed.

Furthermore, it is preferable that the liquid is discharged from the sensor unit when the inlet path is connected to the discharge path.

It is preferable to further include a switching mechanism that switches between the supply path and the inlet path, the supply path and the discharge path, and the inlet path and the discharge path.

For a simpler configuration, the switching mechanism preferably includes a manually operable three-way valve.

The present invention includes not only the calibration module as described above but also a measurement system including a sensor unit and the calibration module.

The present invention can provide a calibration module capable of calibrating a sensor with the simplest possible configuration.

### BRIEF DESCRIPTION OF THE DRAWINGS

FIG. 1 is a schematic diagram of a multi-sensor system including sensor units to be mounted on a calibration module according to an embodiment of the present invention;

FIG. 2 is a schematic diagram of the multi-sensor system including the sensor units to be mounted on the calibration module according to the embodiment of the present invention;

FIG. 3 is a schematic diagram of the calibration module according to the present embodiment;

FIG. 4 is a flow path development diagram of the calibration module according to the present embodiment;

FIG. 5 is a schematic diagram illustrating a connection between the calibration module and the sensor unit according to the present embodiment;

FIG. 6 is a schematic diagram illustrating the connection between the calibration module and the sensor unit according to the present embodiment;

FIG. 7 is a flow path development diagram of a calibration module according to another embodiment of the present invention;

FIG. 8 is a flow path development diagram of a calibration module according to another embodiment of the present invention; and

FIG. 9 is a flow path development diagram of a calibration module according to another embodiment of the present invention.

### DETAILED DESCRIPTION

Hereinafter, a calibration module 100 and a measurement system 200 according to an embodiment of the present invention will be described with reference to the drawings. In the present specification, the up-and-down direction means the vertical direction. A high position means an upper position in the vertical direction, and a low position means a lower position in the vertical direction, unless otherwise specified.

The calibration module 100 according to the present embodiment is used, for example, when individual sensor units S incorporated in a multi-sensor system M as described below are removed from the multi-sensor system and calibrated.

### Multi-Sensor System

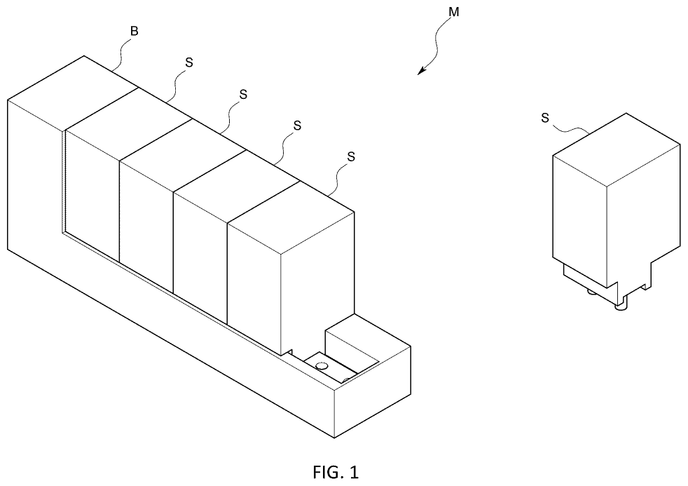

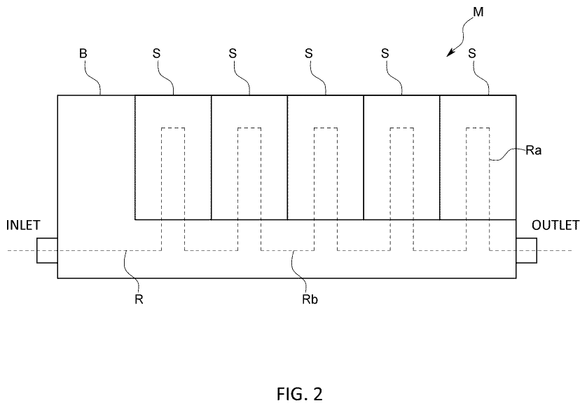

The multi-sensor system M described above measures, for example, fluids as illustrated in FIG. 1 or 2. The fluids are not limited to particular types, and include, for example, not only a liquid but also a gas, a mixture of a liquid and a gas, a mixture of a liquid and a solid, and the like.

The multi-sensor system M includes, for example, a plurality of sensor units S for measuring a fluid, and a main body B to which each sensor unit S is removably attached. Here, the name of the multi-sensor system M is used for convenience, but the number of the sensor units S mounted is not particularly limited, and may be one or two or more, for example.

As illustrated in FIG. 2, the multi-sensor system M includes, as in the present embodiment, for example, an inlet through which a fluid such as a liquid to be measured is introduced, an outlet through which the fluid is discharged, and a flow path R through which the fluid flows from the inlet to the outlet. For example, the sensor units S may include a measurement flow path Ra through which the fluid flows. The main body B may include a main body flow path Rb through which the fluid flows. The sensor units S may be mounted on the main body B to connect the measurement flow path Ra and the main body flow path Rb to constitute the flow path R.

For example, in the case where the multi-sensor system M described above measures values related to water, the sensor units S may be, for example, a turbidimeter, a chromometer, a PH meter, a residual chlorine concentration meter, a conductivity meter, a flowmeter, a water temperature meter, and the like. Note that as the plurality of sensor units S, the multi-sensor system M may include a plurality of sensor units S that measures the same value on the fluid, or may include sensor units S that measure different values.

### Sensor Unit

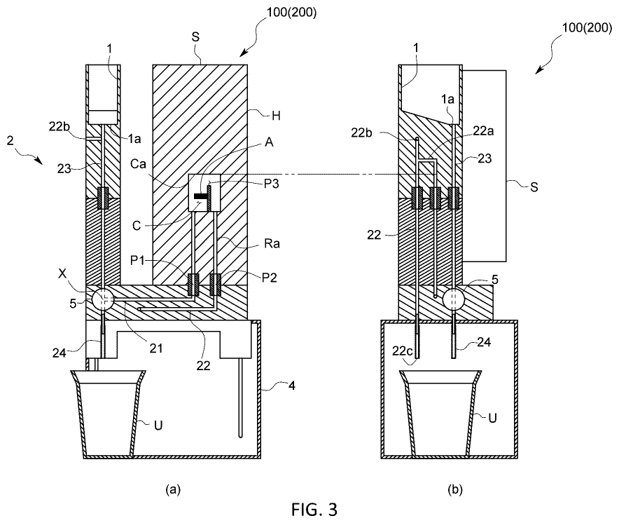

As illustrated in FIG. 3(a), for example, each sensor unit S includes the measurement flow path Ra, a cell C provided on the measurement flow path Ra, a sensor A disposed in the cell C, and a housing H accommodating them inside.

The measurement flow path Ra is formed, for example, between an inlet port P1 and an outlet port P2 provided at the lower end of the housing H. The cell C is provided above the inlet port P1 and the outlet port P2 of the measurement flow path Ra. Specifically, the inlet port P1 and the outlet port P2 are openings formed in the bottom of the housing H.

In the present embodiment, it is preferable that the measurement flow path Ra is formed in a resin block forming the housing H, and the portions other than the inlet port P1 and the outlet port P2 are hermetically sealed.

The cell C accommodates the sensor A such that when the interior of the cell C is filled with a fluid such as a liquid to be measured or a calibration solution, a characteristic value of the fluid can be measured by the sensor A. The cell C, which is not limited to a particular material, is formed of glass, an acrylic resin, a fluororesin, a silicon resin, or the like, and is, for example, a cylindrical one with its axial direction in the up-and-down direction. The outer diameter of the cell C is, for example, 34 mm or more and 36 mm or less.

The upper end face Ca of the cell C may be formed, for example, by the inner surface of the housing H. It is preferable that an overflow outlet P3 through which the fluid that has filled the interior of the cell C up to a portion above the position at which the sensor A is disposed overflows toward the outlet port P2 is formed in an upper end portion of the cell C.

The sensor unit S preferably includes, for example, a wireless communication means such as Wi-Fi or a wireless LAN, or a wired communication means such as a communication cable or a wired LAN. The sensor unit S may be connectable to a communication device such as a mobile terminal (for example, a smart device, a tablet computer, a notebook personal computer, or the like) with the communication means.

### Calibration Module

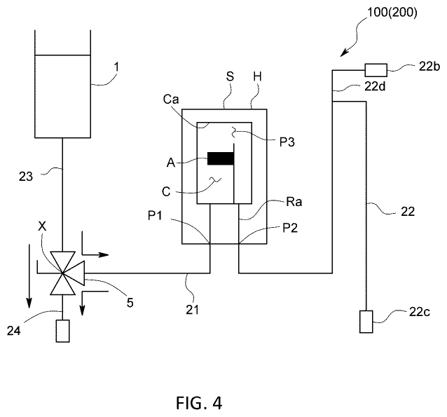

Thus, as illustrated in FIGS. 3 and 4, the calibration module 100 according to the present embodiment includes a tank 1 that holds a liquid such as a calibration solution to be supplied to the sensor unit S, a calibration flow path 2 for circulating the liquid, a connection 6 for connecting the sensor unit S, and a pedestal 4 that supports the sensor unit S.

The tank 1 can hold therein a liquid such as a calibration solution or a cleaning solution necessary for calibration or cleaning of the sensor unit S. In the present embodiment, the tank 1 is a recess formed in a distal end portion of a rectangular resin block from its upper end toward the interior. The tank 1 is disposed at a higher position than the inlet port P1 of the sensor unit S so that the liquid level of the liquid held in the tank 1 is at a higher position than the inlet port P1 of the sensor unit S. More specifically, the tank 1 is disposed at a higher position than the inlet port P1 of the sensor unit S so that the liquid level of the liquid held in the tank 1 is at a vertically upper position. In order to sufficiently fill the interior of the cell C of the sensor unit S with the liquid, it is preferable that the bottom 1a of the tank 1 is provided at a position higher than the position of the inlet port P1, and it is more preferable that the bottom 1a of the tank 1 is provided at a position higher than the position of the sensor A disposed in the cell C. Since the bottom 1a of the tank 1 is thus provided at a position higher than the position of the sensor A, the calibration solution supplied from the tank 1 by the hydraulic head can be reliably raised to the height at which the sensor A is provided, which is preferable.

The calibration flow path 2 includes, for example, an inlet path 21 that is connected to the inlet port P1 of the sensor unit S to introduce the liquid supplied from the tank 1 into the measurement flow path Ra of the sensor unit S, an outlet path 22 that is connected to the outlet port P2 of the sensor unit S to discharge excess liquid from the measurement flow path Ra of the sensor unit S to an outlet, a supply path 23 to supply the liquid from the tank 1 to the inlet path 21, and a discharge path 24 to discharge the liquid stored in the sensor unit S to the outside.

In the present embodiment, the inlet path 21 and the outlet path 22 are formed, for example, in a resin block mounted on the pedestal 4 on top of which the sensor unit S can be disposed. Portions of the supply path 23, the discharge path 24, and the outlet path 22 are formed in the same resin block as the resin block in which the tank 1 is formed. These resin blocks are configured, for example, to be removably attached to the pedestal 4, and can be divided into several resin blocks after being removed from the pedestal 4, housed in the pedestal 4 to be carried, and reassembled at the time of use.

The supply path 23 is formed to connect the bottom 1a of the tank 1 and the inlet path 21, for example. The supply path 23 is also formed to be connected to the discharge path 24. The discharge path 24 is formed to be connected not only to the supply path 23 but also to the inlet path 21. A switching mechanism 5 is provided at the contact of the supply path 23, the discharge path 24, and the inlet path 21 to switch the connection destination between these flow paths.

In the present embodiment, the resin block in which the supply path 23 and the discharge path 24 are formed is disposed side by side with the resin block in which the inlet path 21 and the outlet path 22 are formed so that the calibration flow path 2 has the above-described configuration. Consequently, the inlet path 21 and the supply path 23, and the inlet path 21 and the discharge path 24 communicate with each other.

The outlet path 22 includes a high portion 22a disposed at a higher position than the lower end of the discharge path 24, preferably at a higher position than the connection X between the inlet path 21 and the discharge path 24, more preferably at a higher position than the upper end face Ca of the cell C of the sensor unit S. The high portion 22a is preferably formed in the same resin block as the tank 1. In order to reliably fill the measurement flow path Ra of the sensor unit S with the liquid from the tank 1, the highest portion of the high portion 22a is preferably disposed at a position lower than the bottom 1a of the tank 1 and higher than the upper end face Ca of the cell (the highest position of the measurement flow path Ra).

Further, the high portion 22a of the outlet path 22 is preferably provided, for example, with an atmospheric opening 22b bored from a side wall of the resin block toward the high portion 22a. The atmospheric opening 22b is preferably provided at a higher position than the connection between the inlet path 21 and the discharge path 24, more preferably at a higher position than the upper end face Ca of the cell C of the sensor unit S, and is preferably provided at a position higher than the highest position of the high portion 22a.

The downstream side of the high portion 22a of the outlet path 22 described above is preferably connected to an outlet 22c disposed below the atmospheric opening 22b. The outlet 22c is for discharging excess liquid that has flowed through the outlet path 22 and flowed out beyond the highest position of the high portion 22a to the outside.

Furthermore, the inner diameter of the outlet path 22 on the side close to the outlet 22c is preferably greater than that on the side close to the outlet port P2. More specifically, the inner diameter of the outlet path 22 downstream of the position at which the outlet path 22 communicates with the atmospheric opening 22b is preferably greater than the inner diameter of the outlet path 22 upstream thereof.

Further, in order to dispose the lower end of the discharge path 24 as low as possible, the pedestal 4 preferably includes a space for accommodating a container U for receiving waste liquid below it.

The switching mechanism 5 may include a plurality of valve elements or the like. However, for a simpler configuration, the switching mechanism 5 preferably includes a three-way valve. An example of the switching mechanism 5 like this is, for example, a three-way valve that includes a knob so as to be easily operated manually, and allows the connection destination of each flow path to be changed by rotating the knob, for example, 90° at a time.

### Description of Connection

As described above, the calibration module 100 according to the present embodiment includes the connection 6 that connects the measurement flow path Ra of the sensor unit S and the calibration flow path 2.

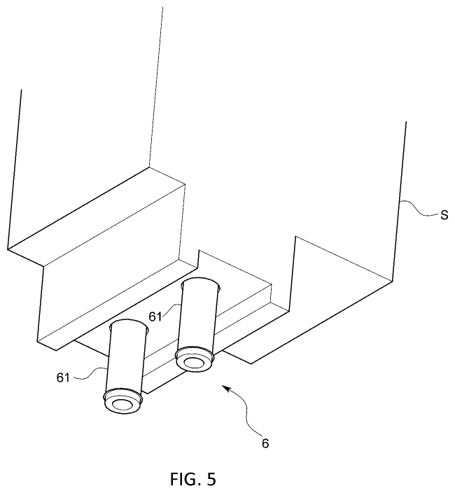

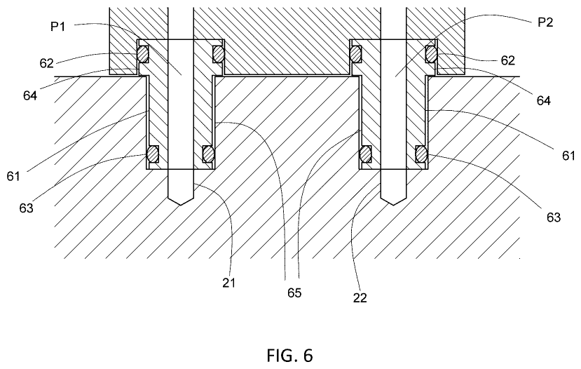

For example, as illustrated in FIGS. 5 and 6, the connection 6 may include two connecting pipes 61 that are straight pipes extending linearly through which a fluid flows, first elastic bodies 62 that seal the spaces between the connecting pipes 61 and the sensor unit S, and second elastic bodies 63 that seal the spaces between the connecting pipes 61 and the calibration module 100.

As described above, the sensor unit S includes the inlet port P1 and the outlet port P2 formed at the ends of the measurement flow path Ra. Each of the two connecting pipes 61 includes, at a first end thereof, a first pipe insertion portion 64 that is inserted into the inlet port P1 or the outlet port P2. Each first elastic body 62 is formed in an annular shape and is disposed between the outer peripheral portion of the first pipe insertion portion 64 and the inner peripheral portion of the inlet port P1 or the outlet port P2.

With this configuration, each first elastic body 62 is elastically deformed uniformly over the entire circumference, so that the space between the outer peripheral portion of the first pipe insertion portion 64 and the inner peripheral portion of the inlet port P1 or the outlet port P2 is sealed by the first clastic body 62. Note that the first elastic bodies 62 are not limited to a particular configuration. The first elastic bodies 62 may be of any configuration as long as they are elastically deformable in the radial direction, and may be, for example, O-rings.

The inlet path 21 and the outlet path 22 of the calibration module 100 include connection ports at their ends that are connected to the measurement flow path Ra of the sensor unit S. The connecting pipes 61 include, at second ends, second pipe insertion portions 65 that are inserted into the connection ports. Each second elastic body 63 is formed in an annular shape and is disposed between the outer peripheral portion of the second pipe insertion portion 65 and the inner peripheral portion of the connection port.

With this configuration, each second elastic body 63 is elastically deformed uniformly over the entire circumference, so that the space between the outer peripheral portion of the second pipe insertion portion 65 and the inner peripheral portion of the connection port of the calibration module 100 is sealed by the second elastic body 63. Note that the second elastic bodies 63 are not limited to a particular configuration. The second elastic bodies 63 may be of any configuration as long as they are elastically deformable in the radial direction, and may be, for example, O-rings.

### Method of Calibrating Sensor Unit Using Calibration Module

First, the sensor unit S is mounted on the calibration module 100 via the connection, and a calibration solution for calibrating the sensor unit S is injected into the tank 1.

At this time, the end of the supply path 23 connected to the inlet path 21 may be sealed by the three-way valve constituting the switching mechanism 5. However, in the present embodiment, the three-way valve is set at an initial position (first position), and the liquid is injected into the tank 1 with the supply path 23 connected to the inlet path 21. For the liquid held in the tank 1, due to the difference in height in the vertical direction between the liquid level of the liquid and the inlet port P1 of the sensor unit S, the liquid in the tank 1 is introduced from the inlet port Pl into the cell C of the sensor unit S through the supply path 23 and the inlet path 21 by the hydraulic head.

Whether the liquid supplied from the tank 1 has reached the position of the sensor A can be determined using the height of the liquid remaining in the tank 1 or in the supply path 23. This is because when the liquid level of the liquid flowing from the tank 1 through the supply path 23 and flowing into the sensor unit S becomes the same level as the liquid level of the liquid that has flowed into the sensor unit S from the inlet port P1 provided at the bottom of the sensor unit S, the hydraulic head is balanced and the flow of the liquid stops, so that the height of the liquid level in the tank 1 or the supply path 23 when the flow stops represents the height of the liquid level in the sensor unit S.

An excess of the calibration solution that has been introduced into the cell C of the sensor unit S and filled the interior of the cell C flows into the outlet path 22 from the outlet port P2, liquid-tightly filling the interior of the cell C and the outlet path 22. At this time, it is sufficient that the calibration solution fill the space from the inlet port P1 to the outlet port P2 of the sensor unit S. However, it is preferable that the calibration solution fills the space from the inlet port P1 of the sensor unit S to the high portion 22a of the outlet path 22 described above, and it is more preferable that the calibration solution fills the space from the inlet port P1 of the sensor unit S to the highest position of the high portion 22a.

Next, the three-way valve is rotated, for example, 90° to be set to a second position for connecting the supply path 23 and the discharge path 24 while sealing the end of the inlet path 21 on the tank 1 side, so that the connection destination of the supply path 23 connected to the inlet path 21 is switched to the discharge path 24, and the end of the inlet path 21 on the tank side is sealed. At this time, since the liquid level of the calibration solution remaining in the supply path 23 is placed above the lower end of the discharge path 24, the calibration solution remaining in the supply path 23 is discharged from the discharge path 24 to the outside by the hydraulic head.

In the state where the inlet path 21 and the measurement flow path Ra in the cell C of the sensor unit S are liquid-tightly filled and the flow of the liquid has stopped in this way, the sensor A included in the sensor unit S is calibrated. Calibration work may be performed by connecting the sensor unit S to a terminal such as a smartphone or the like with the communication means described above.

After the calibration is completed, the three-way valve is further rotated, for example, 90° to be set to a third position to connect the inlet path 21 and the discharge path 24, so that the inlet path 21 and the discharge path 24 are connected, and the calibration solution flows backward from the sensor unit S through the inlet path 21 and is discharged from the discharge path 24 to the outside.

At this time, since the atmospheric opening 22b bored, for example, from the side wall of the resin block to the outlet path 22 is provided on the outlet path 22, and the atmospheric opening 22b is provided at a higher position than the connection X between the inlet path 21 and the discharge path 24, the liquid introduced into the sensor unit S can be discharged from the discharge path 24 through the inlet port P1 by the hydraulic head.

### Effects of Calibration Module and Calibration Method According to the Present Embodiment

Since the calibration solution is introduced into or discharged from the sensor unit S liquid-tightly connected by the hydraulic head, the sensor unit S can be calibrated with the simplest possible configuration without using a flow rate control mechanism that is driven using a power source as in the conventional manner.

The calibration module 100 of this very simple configuration allows calibration work to be performed without problems even in a place where it is difficult to provide a power source, for example.

Further, as compared with the case where a calibration solution is injected with a syringe or the like, it is possible to adjust the flow rate to a constant value using the position, capacity, and the like of the tank 1. It is possible to easily achieve the flow rate at which bubbles and the like hardly enter and calibration can be performed as accurately as possible, regardless of the skill of the worker.

The tank 1 and the calibration flow path 2 are formed inside the resin blocks, and the resin blocks can be removed and replaced. Thus, it is also easy to change the inner diameter, length, and the like of the flow path according to the sensor unit S to be calibrated.

With a certain amount of the calibration solution stored in the cell C, the flow is stopped and calibration is performed. Consequently, the amount of the calibration solution to be used can be minimized, and the cost and the environmental load of the calibration work can be reduced to a minimum.

The liquid remaining in the supply path 23 is discharged before the liquid in the cell C is discharged. Consequently, it is possible to minimize the remaining of a liquid in the supply path 23 to prevent a liquid newly introduced from the tank 1 through the supply path 23 into the sensor unit S from being mixed with another type of liquid that has flowed through the supply path 23 before that. Therefore, the amount of liquid to be used to clean the interior of the flow path or replace a liquid in the flow path can be minimized.

The measurement flow path Ra is connected to the calibration flow path 2 by the connection 6 as described above, the first elastic bodies 62 seal the spaces between the connecting pipes 61 and the sensor unit, and the second clastic bodies 63 seal the spaces between the connecting pipes 61 and the calibration module. Consequently, the sensor unit S can be reliably connected to the calibration module 100 without leakage of the fluid from the flow paths, for example.

### Modification

The present invention is not limited to the above-described embodiment.

For example, the above-described calibration module can be used not only as the calibration module but also for measurement as the measurement system 200 in which a liquid to be measured is injected into the tank, the sensor unit is filled with the liquid to be measured by the hydraulic head, and a characteristic of the liquid to be measured is measured by the sensor included in the sensor unit with the inlet path and the measurement flow path described above liquid-tightly filled with the liquid to be measured.

The above embodiment has described the sensor unit that is removably attached to the calibration module. However, the present invention is not limited to this. The calibration module and the sensor unit may be inseparably integrated as a calibration system or a measurement system.

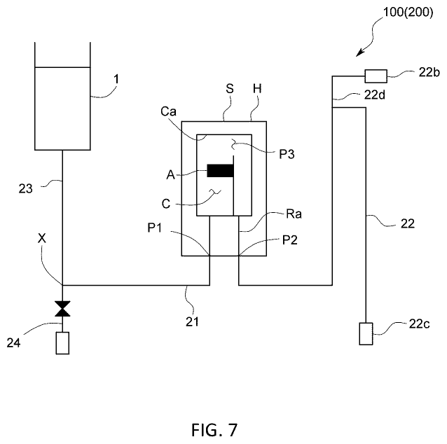

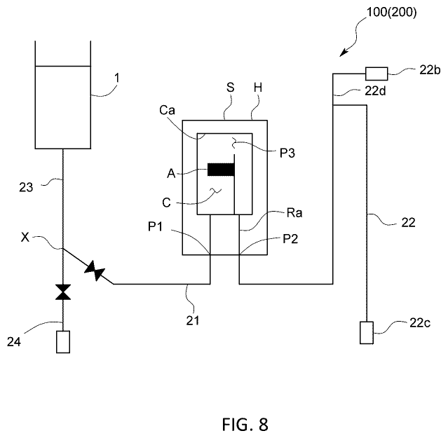

The above-described embodiment has described the case where the switching mechanism is provided at the connection between the supply path, the inlet path, and the discharge path. However, the present invention is not limited to this. For example, as illustrated in FIG. 7 or 8, a simpler configuration without a switching mechanism in the first place may be used. In this case, for example, as illustrated in FIG. 7, a flow rate control mechanism such as a manually openable and closable valve element that controls the flow rate of the fluid may be provided only on the discharge path, or as illustrated in FIG. 8, flow rate control mechanisms such as manually openable and closable valve elements may be provided on the discharge path and the inlet path. Also in this case, the connection between the supply path, the inlet path, and the discharge path is preferably provided at a lower position than the high portion of the outlet path, and the position of the flow rate control mechanism provided on the discharge path is preferably provided at a lower position than the high portion of the outlet path.

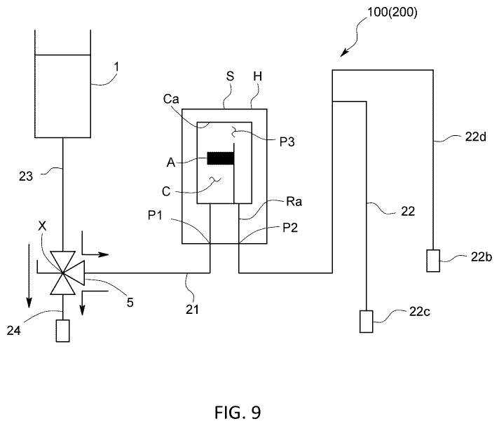

The above-described embodiment has described the case where the atmospheric opening 22b is provided at a higher position than the high portion 22a of the outlet path 22. However, as illustrated in FIG. 9, for example, the atmospheric opening 22b may be provided at a lower position than the high portion 22a. In this case, part of an atmospheric release flow path 22d connecting the high portion 22a and the atmospheric opening 22b preferably includes a portion higher than the high portion 22a.

Furthermore, the supply path, the discharge path, the inlet path, and the outlet path may not be formed in the resin blocks described above, and each may be formed by appropriate piping.

In the above-described embodiment, the atmospheric opening is provided on the outlet path since the measurement flow path and the calibration flow path are airtightly connected. However, the atmospheric opening does not necessarily need to be provided on the outlet path. For example, the atmospheric opening may be provided at a position on the measurement flow path included in the sensor unit downstream of the cell and above the connection between the inlet path and the discharge path, or the like.

It goes without saying that various modifications and combinations can be made without departing from the spirit and scope of the present invention.

### REFERENCE CHARACTER LIST

200 measurement system
100 calibration module
1 tank
21 inlet path
22 outlet path
22a high portion
22b atmospheric opening
23 supply path
24 discharge path
5 switching mechanism
S sensor unit
Ra measurement flow path
A sensor
P1 inlet port
P2 outlet port

1. A calibration module comprising:
a tank to hold a liquid;
an inlet path connected to an inlet port of a sensor unit including a sensor to introduce the liquid supplied from the tank into the sensor unit; and
an outlet path connected to an outlet port of the sensor unit to discharge the liquid from an interior of the sensor,
wherein the inlet path introduces the liquid into the sensor unit by a hydraulic head between the tank and the inlet port.

2. The calibration module according to claim 1, further comprising an atmospheric opening provided on the outlet path, the atmospheric opening being provided at a higher position than the inlet port.

3. The calibration module according to claim 1, further comprising a discharge path that is connected to the inlet path to discharge the liquid discharged from the sensor unit to an outside,
wherein the outlet path includes a high portion disposed at a higher position than a connection between the inlet path and the discharge path.

4. The calibration module according to claim 3, wherein the high portion is provided at a lower position than a bottom of the tank.

5. The calibration module according to claim 3, wherein the high portion is provided at a higher position than a highest portion of a measurement flow path formed in the sensor unit.

6. The calibration module according to claim 3 referring to claim 2, wherein the atmospheric opening is provided at a higher position than a highest portion of the high portion.

7. The calibration module according to claim 3, further comprising a supply path to supply the liquid from the tank to the inlet path,
wherein the liquid is supplied to the sensor unit when the supply path is connected to the inlet path.

8. The calibration module according to claim 7, wherein the liquid remaining in the supply path can be discharged when a connection destination of the supply path connected to the inlet path is switched to the discharge path and an end of the inlet path on a side of the tank is sealed.

9. The calibration module according to claim 8, wherein the liquid is discharged from the sensor unit when the inlet path is connected to the discharge path.

10. The calibration module according to claim 9, further comprising a switching mechanism that switchably connects the supply path and the inlet path, the supply path and the discharge path, and the inlet path and the discharge path.

11. The calibration module according to claim 10, wherein the switching mechanism is a manually operable three-way valve.

12. A measurement system comprising:
a tank to hold a liquid;
a sensor unit including a sensor to measure the liquid;
an inlet path connected to an inlet port of the sensor unit to introduce the liquid supplied from the tank into the sensor unit; and
an outlet path connected to an outlet port of the sensor unit to discharge the liquid from an interior of the sensor,
wherein the inlet path introduces the liquid into the sensor unit by a hydraulic head between the tank and the inlet port.

13. The measurement system according to claim 12, wherein the sensor unit is one of a turbidimeter, a chromometer, a pH meter, a residual chlorine concentration meter, a conductivity meter, a flowmeter, and a water temperature meter.

14. A sensor calibration method in which a liquid held in a tank is introduced through an inlet path connected to an inlet port of a sensor unit including a sensor into the sensor unit, the sensor calibration method comprising:
introducing the liquid into the sensor unit by a hydraulic head between the tank and the inlet port; and
calibrating the sensor with the inlet path and a measurement flow path filled with the liquid.

15. A measurement method in which a liquid held in a tank is introduced through an inlet path connected to an inlet port of a sensor unit including a sensor into the sensor unit, the measurement method comprising:
introducing the liquid into the sensor unit by a hydraulic head between the tank and the inlet port; and
calibrating the sensor with the inlet path and a measurement flow path filled with the liquid.
